(19) United States
(12) Patent Application Publication
(10) Pub. No.: US 2020/0376862 A1
(43) Pub. Date: Dec. 3, 2020

(54) PRINTED MATTER PRODUCTION METHOD AND PRINTING SYSTEM

(71) Applicant: SEIKO EPSON CORPORATION, Tokyo (JP)

(72) Inventors: Yo KAWANO, Matsumoto (JP); Yusuke KOIZUMI, Shiojiri (JP); Eiki SUZUKI, Matsumoto (JP)

(21) Appl. No.: 16/886,891

(22) Filed: May 29, 2020

(30) Foreign Application Priority Data
May 31, 2019 (JP) 2019-102219

(51) Int. Cl. B41J 15/04; B41J 29/02; B41J 11/00

(52) U.S. Cl. CPC B41J 15/04; B41J 11/0095; B41J 29/02

(57) ABSTRACT

A printed matter production method for producing a printed matter by using a base and a cover provided with a clearance includes pinching a print medium, performing first printing on an area exposed from the clearance of the cover in the print medium, shifting a relative position, and performing second printing on an unprinted area exposed from the clearance of the cover in the print medium that is pinched again.

The present application is based on, and claims priority from JP Application Serial Number 2019-102219, filed May 31, 2019, the disclosure of which is hereby incorporated by reference herein in its entirety.

### BACKGROUND

### 1. Technical Field

The present disclosure relates to a printed matter production method and a printing system.

### 2. Related Art

A technique has been known which transports a print medium having an infinite form by pinching the print medium by a carrier sheet and performs printing. For example, JP-A-2008-10010 describes that printing is performed on an area of a print medium exposed from a cutout portion formed in the carrier sheet.

However, in the method described above, it is not possible to perform printing on a large area of a print medium which cannot be printed as is.

### SUMMARY

The present disclosure is a printed matter production method for producing a printed matter by using a base and a cover provided with a clearance. The printed matter production method includes pinching a print medium between the base and the cover, performing first printing on an area exposed from the clearance of the cover in the print medium, after the first printing, shifting a relative position between the print medium and the cover and pinching again the print medium between the base and the cover, and performing second printing on an unprinted area exposed from the clearance of the cover in the print medium that is pinched again.

In the case of this method, the print medium is pinched by the base and the cover and the first printing is performed on an area of the print medium exposed from the clearance provided in the cover. Thereafter, the relative position between the cover and the print medium is shifted and the print medium is pinched again, so that at least a part of an area of the print medium that is not exposed during the first printing can be newly exposed. The second printing is performed on an unprinted area of the print medium that is pinched again. Therefore, it is possible to perform printing on various areas of the print medium. Further, printing is performed on the print medium in a state where the print medium is pinched between the base and the cover, so that even for a print medium having an infinite form, a posture change, a position shift, and the like with respect to the base are difficult to occur. Therefore, according to this method, even when the print medium has an infinite form, printing can be performed on the print medium.

The present disclosure is a printed matter production method for producing a printed matter by using a first base, a first cover provided with a clearance, a second base, a second cover provided with a clearance in a position different from that of the first cover. The printed matter production method includes pinching a print medium between the first base and the first cover, performing first printing on an area exposed from the clearance of the first cover in the print medium, after the first printing, pinching the print medium between the second base and the second cover, and performing second printing on an unprinted area exposed from the clearance of the second cover in the print medium.

In the case of this method, the print medium is pinched by the first base and the first cover and the first printing is performed on an area of the print medium exposed from the clearance provided in the first cover. Thereafter, the print medium is pinched between the second base and the second cover. The second cover is provided with a clearance in a position different from that of the first cover. Therefore, at least a part of an area of the print medium that is not exposed during the first printing can be newly exposed. The second printing is performed on an unprinted area pinched between the second base and the second cover as described above. Therefore, it is possible to perform printing on various areas of the print medium. Further, printing is performed on the print medium in a state where the print medium is pinched between the base and the cover, so that even the print medium has an infinite form, a posture change, a position shift, and the like with respect to the base are difficult to occur during the printing. Therefore, according to this method, even when the print medium has an infinite form, printing can be performed on the print medium.

Further, the present disclosure is a printed matter production method in which an exposed area is recognized by reading the print medium in a state of being pinched and printing may be performed on the recognized area in the first printing.

An area that is not exposed in a state of being pinched between the base and the cover is blocked by the cover, so that printing cannot be performed on the area. However, an exposed area is not blocked by the cover, so that printing can be performed on the area. Therefore, according to this method, an area exposed from the clearance of the cover in a state of being pinched between the base and the cover is recognized in advance by reading the area, and the first printing can be performed on the recognized area.

Further, the present disclosure is a printed matter production method in which an exposed unprinted area is recognized by reading the print medium in a state of being pinched and printing may be performed on the recognized unprinted area in the second printing.

An area that is not exposed in a state of being pinched between the base and the cover is blocked by the cover, so that printing cannot be performed on the area. However, an exposed area is not blocked by the cover, so that printing can be performed on the area. According to this method, an area exposed from the clearance of the cover in a state of being pinched between the base and the cover can be recognized in advance by reading the area. Further, an unprinted area in the exposed area can be recognized in advance by reading the unprinted area (a printed area in the exposed area can be recognized by reading the printed area). Therefore, according to this method, the second printing can be performed on the unprinted area in the area exposed from the clearance of the cover in a state of being pinched between the base and the cover.

Further, the present disclosure is a printed matter production method in which after the second printing, a relative position between the print medium and the cover is shifted, the print medium is pinched again, and third printing may be performed on the unprinted area exposed from the cover.

According to this method, when all the print data to be printed on the print medium has not yet been printed even after the first printing and the second printing, (at least a part of) the remaining print data can be printed by the third printing.

Further, the present disclosure is a printed matter production method in which after the second printing, the print medium is pinched by a third cover provided with a clearance in a position different from those in both the first cover and the second cover instead of the second cover, and third printing may be performed on an unprinted area exposed from the clearance of the third cover.

According to this method, when all the print data to be printed on the print medium has not yet been printed even after the first printing and the second printing, (at least a part of) the remaining print data can be printed by the third printing.

Further, the present disclosure is a printed matter production method in which a surface of the base, which comes into contact with the print medium, may have adhesiveness.

In this case, it is possible to reduce the possibility that the print quality is degraded due to a shift of the print medium with respect to the base.

Further, the present disclosure is a printed matter production method in which surfaces of the first base and the second base, which come into contact with the print medium, may have adhesiveness.

In this case, it is possible to reduce the possibility that the print quality is degraded due to a shift of the print medium with respect to the first base and/or the second base.

Further, the present disclosure is a printed matter production method in which at least either one of the first printing and the second printing may be performed on an area of the print medium exposed from a clearance of an auxiliary cover in a state in which the print medium is pinched with the auxiliary cover where a clearance is formed.

Specifically, the print medium is pinched by two covers and the base, and printing may be performed on an area which is exposed from a clearance of one cover and which is also exposed from a clearance of the other cover. By using the two covers, the shape of the area from which the print medium is exposed can be various shapes according to an overlapping manner of the two covers. As a result, it is possible to perform printing on, for example, a print medium having a complicated shape and a print medium smaller than a clearance of a cover.

Further, the present disclosure is a printed matter production method in which the first base and the second base are the same base.

That is, the print medium may be pinched by using two covers whose positions of the clearance are different from each other on one base.

The present disclosure is a printing system that performs printing on a print medium pinched by a base and a cover provided with a clearance. The printing system includes a printing unit, a discrimination unit that discriminates an area of the print medium exposed from the clearance of the cover, and a control unit that causes the printing unit to perform first printing on the area based on a discrimination result. After the first printing, the discrimination unit discriminates an unprinted area of the print medium exposed from the clearance of the cover, and the control unit causes the printing unit to perform second printing on the unprinted area based on a discrimination result.

According to this configuration, the print medium is pinched by the base and the cover and the first printing is performed on an area of the print medium exposed from the clearance provided in the cover. Thereafter, a relative position between the cover and the print medium is shifted and the print medium is pinched again, so that at least a part of an area of the print medium that is not exposed during the first printing can be newly exposed. The second printing is performed on an unprinted area of the print medium that is pinched again. Therefore, it is possible to perform printing on various areas of the print medium. Further, printing is performed on the print medium in a state where the print medium is pinched between the base and the cover, so that even for a print medium having an infinite form, a posture change, a position shift, and the like with respect to the base are difficult to occur. Therefore, according to this configuration, even when the print medium has an infinite form, printing can be performed on the print medium.

### BRIEF DESCRIPTION OF THE DRAWINGS

FIG. 1 is a block diagram showing a configuration of a complex machine.

FIG. 2 is a schematic diagram showing an overview configuration and a transport path of a printing unit.

FIG. 3 is a diagram showing an example of a base.

FIG. 4 is a diagram showing an example of a cover.

FIG. 5 is a diagram showing a situation in which a print medium is pinched between the base and the cover.

FIG. 6 is a flowchart showing a production process of a printed matter.

FIG. 7 is a diagram showing a preview example.

FIG. 8 is a diagram showing a print result after first printing.

FIG. 9 is a schematic diagram showing transport of an infinite form tray pinching a print medium.

FIG. 10 is a schematic diagram showing transport of the infinite form tray pinching the print medium.

FIG. 11 is a schematic diagram showing transport of the infinite form tray pinching the print medium.

FIG. 12 is a diagram showing a situation in which the cover is set for second printing.

FIG. 13 is a diagram showing a print result after the second printing.

FIG. 14 is a diagram showing a print result after third printing.

FIG. 15 is a diagram showing an example of a cover according to a second embodiment.

FIG. 16 is a diagram showing a print result after second printing according to the second embodiment.

FIG. 17 is a diagram showing an example of a method of pinching a print medium according to another embodiment.

FIG. 18 is a diagram showing a printed matter according to another embodiment.

FIG. 19 is a diagram showing an example of a method of pinching a print medium according to the other embodiment.

FIG. 20 is a diagram showing an example of the method of pinching the print medium according to the other embodiment.

FIG. 21 is a diagram showing an example of the method of pinching the print medium according to the other embodiment.

FIG. 22 is a diagram showing an example of the method of pinching the print medium according to the other embodiment.

### DESCRIPTION OF EXEMPLARY EMBODIMENTS

Here, embodiments of the present disclosure will be described in the following order.

### 1. First Embodiment

1-1. Configuration of Printing System:

1-2. Configuration of Infinite Form Tray:

1-3. Printed Matter Production Method:

### 2. Second Embodiment

### 3. Other Embodiments:

### 1. First Embodiment

1-1. Configuration of Printing System

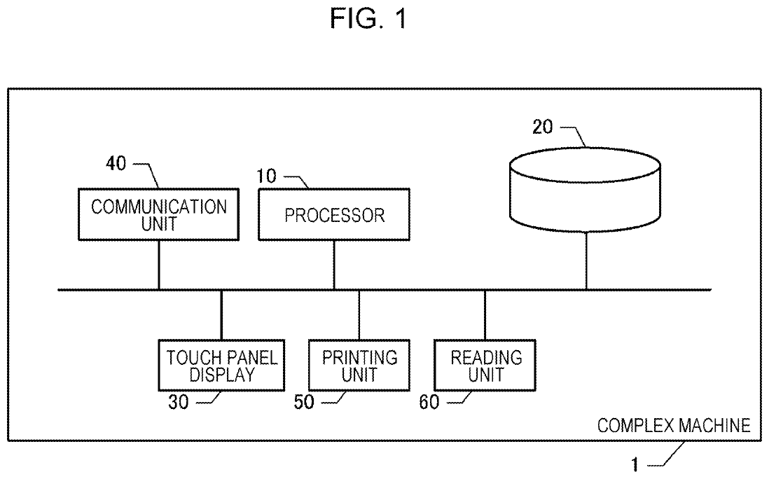

FIG. 1 is a block diagram showing a configuration of a complex machine 1 as a printing system according to an embodiment of the present disclosure. The complex machine 1 includes a processor 10, a non-volatile memory 20, a touch panel display 30, a communication unit 40, a printing unit 50, and a reading unit 60. The processor 10 includes a CPU, a ROM, a RAM, and the like not shown in the drawings and can control each component of the complex machine 1 by executing various programs recorded in the non-volatile memory 20. The processor 10 may be configured by a single chip or may be configured by a plurality of chips. For example, an ASIC may be employed instead of the CPU, or the CPU may cooperate with an ASIC.

The touch panel display 30 includes a display panel that displays various information based on control of the processor 10 and a touch detection panel overlapped on the display panel and detects a touch operation by a human finger or the like. The touch panel display 30 outputs information representing the touch operation to the processor 10.

The communication unit 40 includes various communication interfaces for wiredly and wirelessly communicating with an external device. The communication unit 40 further includes an interface for communicating with various removable memories attached to the complex machine 1.

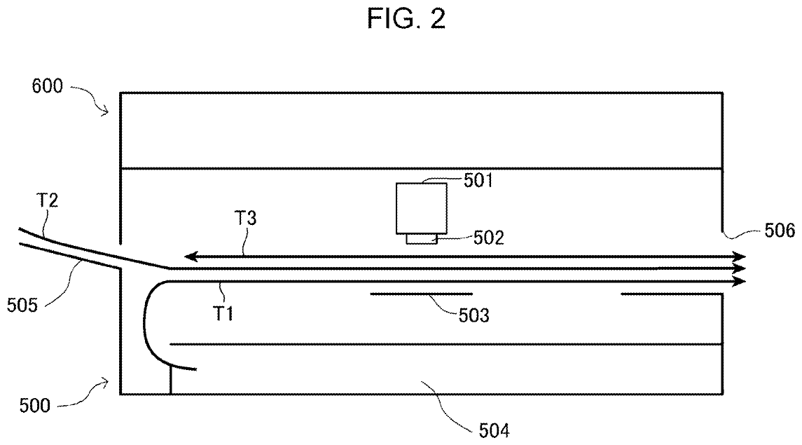

In the present embodiment, the printing unit 50 includes an actuator, a sensor, a drive circuit, machine parts, and the like for performing printing on various print media by a serial ink jet method. FIG. 2 is a schematic diagram for explaining an overview configuration and a transport path of the printing unit 50. As shown in FIG. 2, the printing unit 50 includes a carriage 501, a print head 502, a support base 503, a cassette 504, and a rear paper feed tray 505.

The carriage 501 reciprocates in a main scanning direction along a guide shaft (not shown in the drawings) installed in a state of extending in the main scanning direction. The main scanning direction is parallel to a depth direction of a paper surface of FIG. 2. The print head 502 is mounted on the carriage 501 and discharges ink to a print medium transported over the support base 503. The carriage 501 moves in the main scanning direction and the print head 502 discharges ink to the print medium while the carriage 501 moves, and thereby an image is formed on the print medium. The print head 502 can form a color image and a monochrome image on the print medium by discharging K (black) ink and color inks (for example, C (cyan) ink, M (magenta) ink, Y (yellow) ink, and the like) to the print medium. Of course, the number of inks and the colors of inks are an example, and other color inks may be employed.

The cassette 504 stores print media and is detachably attached to the inside of a housing 500 of the printing unit 50. Reference numeral 600 denotes a housing of the reading unit 60. The printing unit 50 is configured to include one cassette 504. However, of course, the printing unit 50 may be configured to include two or more cassettes. In the case of single-sided printing, a print medium fed from the cassette 504 is transported through a path indicated by T1 and printing is performed on the print medium. That is, the print medium is reversed from a state of being stacked in the cassette 504 and passes vertically below the print head 502. The print medium after being printed is ejected to an opening 506 formed in a front surface of the housing 500.

The rear paper feed tray 505 is attached to the outside of the housing 500 and holds a print medium. In the case of single-sided printing, the print medium fed from the rear paper feed tray 505 to the inside of the housing 500 is transported through a path indicated by T2 and printing is performed on the print medium. That is, the vertically upper surface of the print medium stacked on the rear paper feed tray 505 directly becomes a print surface (the print medium is not reversed). The print medium after being printed is ejected to the opening 506.

The printing unit 50 can perform printing using a disk printing tray (hereinafter referred to as a disk tray) not shown in the drawings. The disk tray holds a disk (for example, CD or DVD) that is a print medium. The disk tray holding a disk is transported through a path indicated by T3 and printing is performed on the disk. That is, when the disk tray is inserted into the opening 506 by a user, the disk tray is transported to the rear paper feed tray 505. After the printing, the disk tray is transported from the rear paper feed tray 505 to the opening 506. A projection portion is formed close to the center of the disk tray, and the projection portion fits into a through hole in the center of the disk, so that the disk is unmovably held. When the disk is set on the disk tray, the entire print surface of the disk is exposed.

In the present embodiment, the printing unit 50 can perform printing using an infinite form printing tray (hereinafter referred to as an infinite form tray) that holds a print medium when performing printing on an infinite form print medium. As described later, the infinite form tray includes a base and a cover and holds a print medium by pinching the print medium between the base and the cover. A clearance (a hole penetrating the cover in the thickness direction) is formed in the cover, and a part of the print surface is exposed from the clearance. The infinite form tray pinching the print medium is transported through the path indicated by T3 and printing is performed on the print medium. That is, when the infinite form tray is inserted into the opening 506 by a user, the infinite form tray is transported to the rear paper feed tray 505. After the printing, the infinite form tray is transported from the rear paper feed tray 505 to the opening 506. The printing is performed when ink is discharged to an area of the print medium that is exposed from the clearance of the cover.

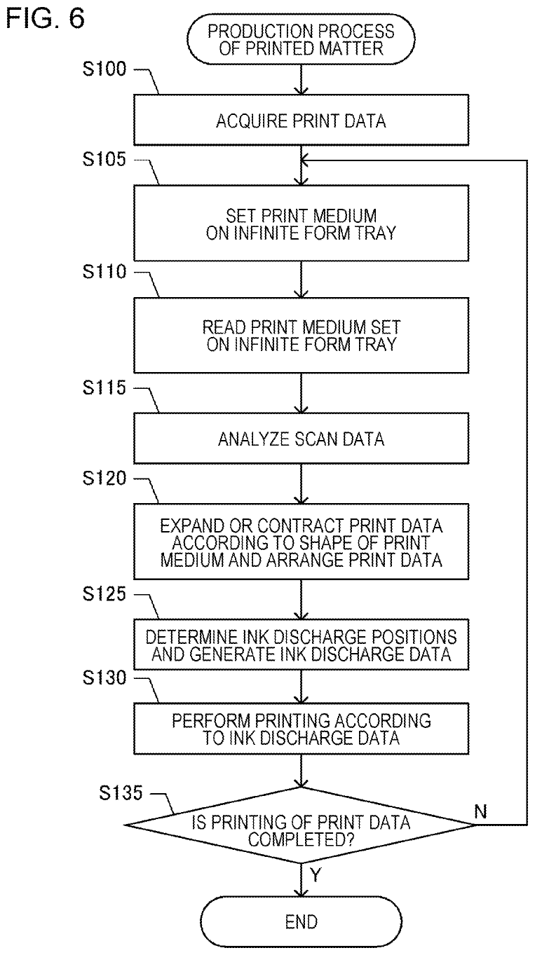

The reading unit 60 includes apparatuses for reading a document set on a document table glass or a document set on an ADF document tray, for example, a known color image sensor, a light source, an actuator for transporting the document, a drive circuit, a sensor, machine parts, and the like. In the present embodiment, in a scan step (S110 in FIG. 6) described later, a print medium pinched by the infinite form tray described later is mounted on the document table glass by a user, and the print medium is read by the reading unit 60.

1-2. Configuration of Infinite Form Tray:

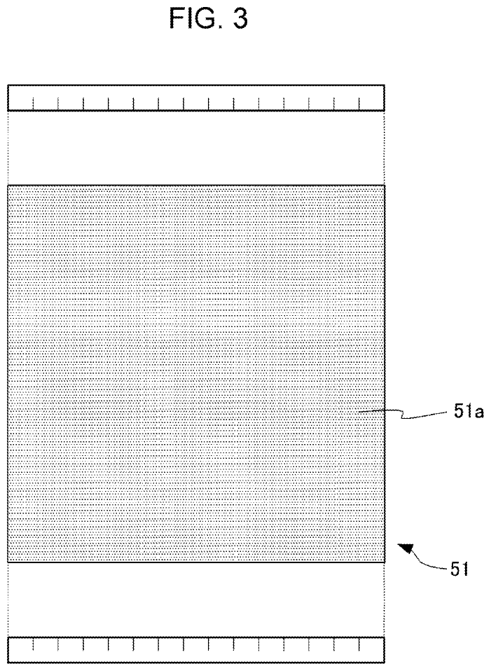

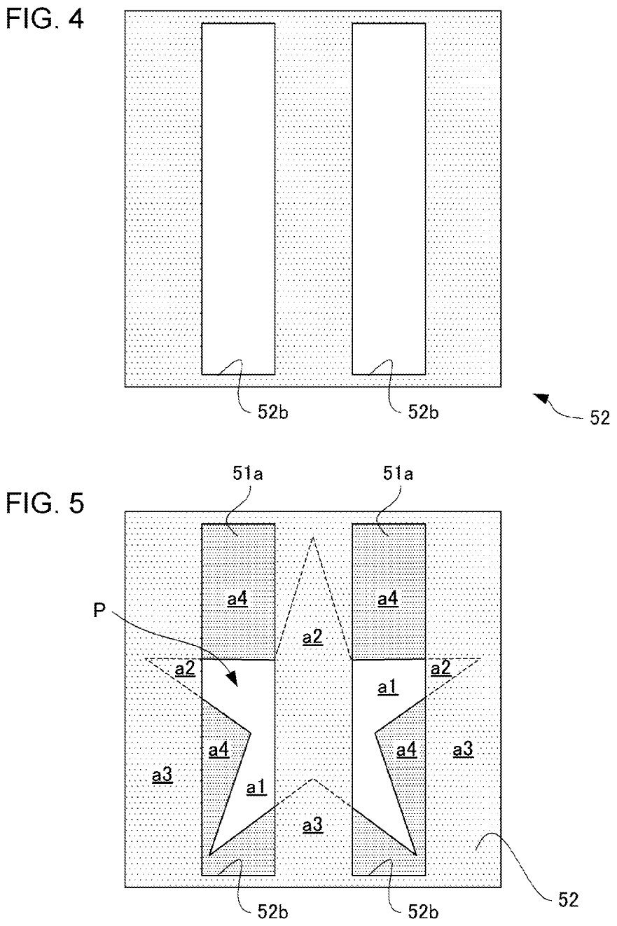

In the present embodiment, the complex machine 1 transports the infinite form tray that pinches a print medium. The complex machine 1 performs printing by repeatedly and alternately performing ink discharge and transportation on the print medium pinched by the infinite form tray. In the present embodiment, as shown in FIGS. 3 and 4, the infinite form tray is composed of a base 51 and a cover 52. FIG. 3 is a top view and a side view of the base 51. The base 51 is a thin plate-like member. The shape of a top surface 51a of the base 51 is a square as shown in FIG. 3 in the present embodiment. The top surface 51a of the base 51 has adhesiveness and prevents a print medium mounted on the top surface 51a of the base 51 from being shifted with respect to the base 51.

In the present embodiment, as shown in FIG. 3, scales are formed along sides of the top surface 51a on a pair of side surfaces parallel to each other of the base 51. Regarding the scale, the scale of the top surface 51a indicates a distance from an end of a corresponding side. As described later, the scale may be used as an indication of a position and a posture where a user sets the cover 52. In the present embodiment, the infinite form tray is inserted into the opening 506 by the user so that side surfaces where the scale is formed are parallel to a sub-scanning direction.

The base 51 may be selected from a plurality of bases, whose colors of the top surface 51a are different from each other, by the user according to color of the print medium. For example, a base whose color of the top surface is different from color of the print surface of the print medium may be selected. When the print medium has a light color, a base whose top surface has a deep color may be selected, and when the print medium has a deep color, a base whose top surface has a light color may be selected. By doing so, it is possible to increase the possibility that the shape of the print medium can be easily recognized when a scan data analysis step (S115 in FIG. 6) described later is performed. When the shape of the print medium is acquired from subtle shadows due to a level difference between end portions of the print medium and the top surface 51a of the base 51, even if the print medium has a light color, a base whose top surface 51a has the same type of light color as that of the print medium may be selected.

FIG. 4 is a top view of the cover 52. In the present embodiment, the cover 52 is a sheet-like member having light transmissivity. As shown in FIG. 4, the shape of outer circumference of the cover 52 is a square having the same size as that of the base 51 in the present embodiment. The cover 52 has light transmissivity where the shape of the print medium located on the opposite side of the cover 52 can be identified through the cover 52. A clearance 52b (a hole penetrating the cover 52 in the thickness direction) is formed in the cover 52. In the present embodiment, the shape of the clearance 52b when the top surface of the cover 52 is viewed is rectangle, and a side of the rectangle is parallel to one of the sides of the outer circumference of the cover 52. The cover 52 has a function to press the print medium against the base 51 and pinch the print medium between the cover 52 and the base 51. Thereby, it is possible to prevent a distance between the print head 502 and the print medium from being unstable due to curl or corrugation of the print medium and also prevent the mounted print medium from being shifted with respect to the base 51. The cover 52 may be selected by the user from a plurality of covers, whose transmittances, colors, and formation positions and shapes of the clearance 52b are different from each other, according to the color of the print medium, the color of the top surface 51a of the base 51, and the like.

FIG. 5 is a diagram showing a situation in which a star-shaped print medium P is pinched between the base 51 and the cover 52. In the example of FIG. 5, the cover 52 is overlapped on the base 51 so that their outer circumferences match each other. The top surface 51a of the base 51 and the print medium P are exposed from the clearance 52b of the cover 52. In FIG. 5, an area a1 is an area of the print medium P exposed from the clearance 52b of the cover 52. An area a2 is an area of the print medium P covered by the cover 52. An area a3 is an area where the top surface 51a of the base 51 and the cover 52 are directly overlapped without the print medium P. An area a4 is an area representing the top surface 51a of the base 51 exposed from the clearance 52b of the cover 52. In the scan data analysis step (S115 in FIG. 6) described later, a cover having a color and a transmittance where the areas a1 to a4 can be recognized from each other may be selected.

For example, a user inputs a type of the base and a type of the cover, which are selected by the user, from the touch panel, and the processor 10 may acquire a color of the base, a color of the cover, and formation positions and shapes of the clearance of the cover, which are used for the current printing. By doing so, the processor 10 can acquire color information for specifying the area a3 and the area a4 in scan data (image data generated by reading by the reading unit 60). The processor 10 can specify that the area a2 whose color is different from that of the area a3 is an area of the print medium covered by the cover 52 based on information of the formation positions and shapes of the clearance of the cover and a distribution of the area a3 in the scan data. Further, the processor 10 can specify that the area a1 whose color is different from that of the area a4 is an area of the print medium exposed from the cover from the information of the formation positions and shapes of the clearance of the cover and a distribution of the area a4 in the scan data. Further, the processor 10 can acquire the shape of the print medium P from distributions of the area a1 and the area a2 in the scan data.

As shown in FIG. 5, regarding the print medium P in a state of being pinched by the infinite form tray, a part of the print medium P is exposed from the clearance 52b of the cover 52, and the remaining part is covered by the cover 52. It is not possible to perform printing on an area covered by the cover 52. Therefore, in the present embodiment, a method is employed in which printing is performed a plurality of times while the cover 52 is shifted with respect to the print medium P. Hereinafter, a specific method of the above will be described.

1-3. Printed Matter Production Method:

FIG. 6 is a flowchart showing a production process of a printed matter using an infinite form tray. First, the processor 10 acquires print data (step S100). That is, the processor 10 acquires print data for performing printing on a print medium by using the infinite form tray. The print data may be acquired in any way. For example, the print data may be acquired by reading a document using the reading unit 60 or may be acquired from a memory card, a smartphone, or a PC through the communication unit 40.

Subsequently, a user sets a print medium on the infinite form tray (step S105). Specifically, the user pinches the print medium P between the base 51 and the cover 52. In the present embodiment, as shown in FIG. 5, an example will be described where printing is performed on the star-shaped print medium P. As described above, in the present embodiment, printing on one print medium is performed divisionally a plurality of times. One time printing is defined as printing from when the infinite form tray pinching the print medium is inserted into the opening 506 (see FIG. 2) to when the infinite form tray is transported, ink discharge is completed, and the infinite form tray is ejected to the opening 506 again. First time printing is called first printing, second time printing is called second printing, and third time printing is called third printing. In the present embodiment, the user mounts the print medium P on the base 51 and pinches the print medium P by the cover 52 before the first printing and performs the first printing, and the user does not move the print medium P with respect to the base 51, shifts the cover 52 with respect to the base 51 and the print medium P, and pinches the print medium P again before the second and subsequent printing. In the present embodiment, the cover 52 of the infinite form tray is shifted in the sub-scanning direction, and the second printing and the third printing are performed. The processor 10 may be configured to guide a setting position (in the sub-scanning direction of the base 51) of the cover 52 before the first printing and a setting position of the cover 52 after the first printing and before the second printing (for example, the processor 10 may guide to set the cover 52 so that an end in the sub-scanning direction of the cover reaches a certain scale mark of the base 51.

Subsequently, the processor 10 reads the print medium in a state of being set on the infinite form tray (step S110). Specifically, the processor 10 prompts the user to mount the infinite form tray in a state where the print medium P is pinched on the document table glass so that the print surface of the print medium P faces the document table glass of the reading unit 60 (that is, so that the print surface faces vertically downward). When the user mounts the infinite form tray on the document table glass according to a guidance and instructs start of reading, the processor 10 controls the reading unit 60 and reads the print medium P in a state of being pinched by the infinite form tray. When the print medium P is read, the scan data is generated.

Subsequently, the processor 10 analyzes the scan data (step S115). Specifically, as shown in FIG. 5, the processor 10 specifies the areas a1, a2, a3, and a4. Further, the processor 10 recognizes that an area composed of the area a1 and the area a2 is the shape of the print surface of the print medium P.

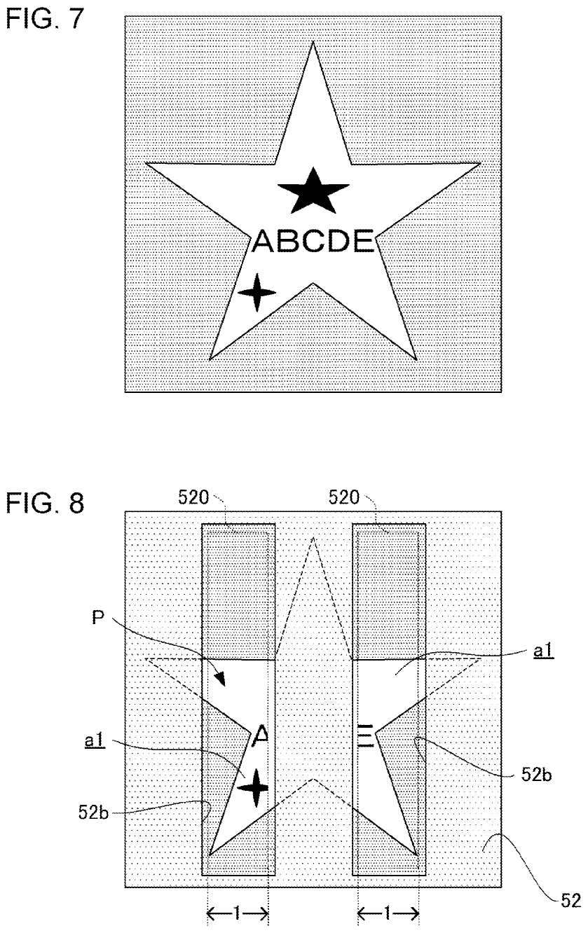

Subsequently, the processor 10 expands or contracts the print data and arranges the print data according to the shape of the print medium (step S120). For example, the processor 10 expands or contracts the print data so that all ink discharge positions indicated by the print data acquired in step S100 are included in a figure inside a predetermined width of a figure representing the shape of the print surface of the print medium P acquired in step S115, and arranges the print data in the figure inside the predetermined width of the figure representing the shape of the print medium. Step S120 may be performed before the first printing (S130), and after the first printing, the second and subsequent step S120 may be omitted. Further, when the size to be printed is specified by the user in advance, step S120 may be omitted from the beginning. The processor 10 may display a preview in a case in which the print data is printed on the print medium P on the touch panel display 30. The user may be able to change a posture, a size, and a position of an image represented by the print data to be arranged on the print surface of the print medium P into desired forms in a state in which the preview is displayed. FIG. 7 shows an example of a preview in a case in which print data composed of characters “ABCDE” and a star-shaped figure is arranged in a star-shaped print medium P. Hereinafter, a production process for obtaining a printed matter as shown by the preview will be described. In the present embodiment, the reading unit 60 and the processor 10 correspond to a discrimination unit.

Subsequently, the processor 10 decides ink discharge positions and generates ink discharge data (step S125). Specifically, the processor 10 specifies an area which is exposed from the clearance 52b of the cover 52 and which is an unprinted area. The processor 10 cuts out print data according to the unprinted area, and generates the ink discharge data indicating an ink discharge amount in each pixel. The unprinted area is an area where ink is not discharged. FIG. 8 shows a print target area 520 of the first printing in the present embodiment. The print target area 520 is an area a predetermined width inside the clearance 52b of the cover 52. In order to prevent the cover and the print medium from being contaminated by ink droplets attached to the cover, in the present embodiment, an area a predetermined width inside the clearance 52b is treated as the print target area. In the present embodiment, the first printing is performed in a state in which the outer circumference of the top surface 51a of the base 51 and the outer circumference of the cover 52 are overlapped without mispositioning. The processor 10 decides ink discharge pixels indicated by the print data located in an area which is the print target area 520 and which is the area a1 as the ink discharge positions as shown in FIG. 8. In the example of FIG. 8, an left end portion of “A” of “ABCDE”, a part of the star-shaped figure located below and left of the characters “ABCDE”, and a right end portion of “E” are the ink discharge positions.

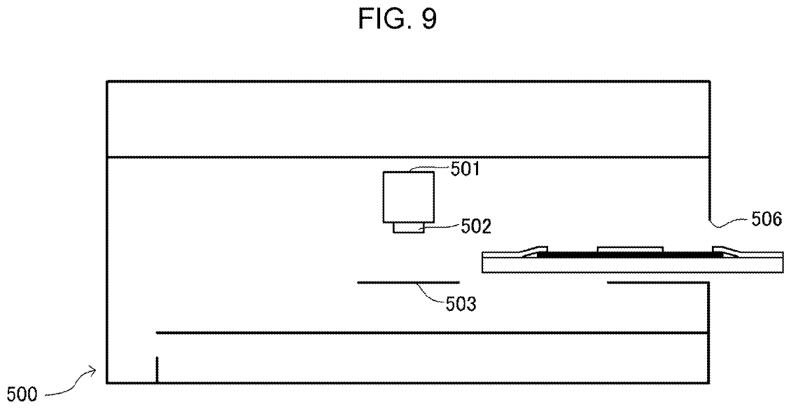

Subsequently, the processor 10 performs printing according to the ink discharge data (step S130). Specifically, the processor 10 guides the user to remove the infinite form tray from the document table glass and insert the infinite form tray into the opening 506 of the housing 500. More specifically, in the present embodiment, as shown in FIG. 9, the processor 10 prompts the user to insert the infinite form tray into the opening 506 in a posture in which the print surface of the print medium P faces the print head 502 and a longitudinal direction of the clearance 52b of the cover 52 is parallel to the main scanning direction.

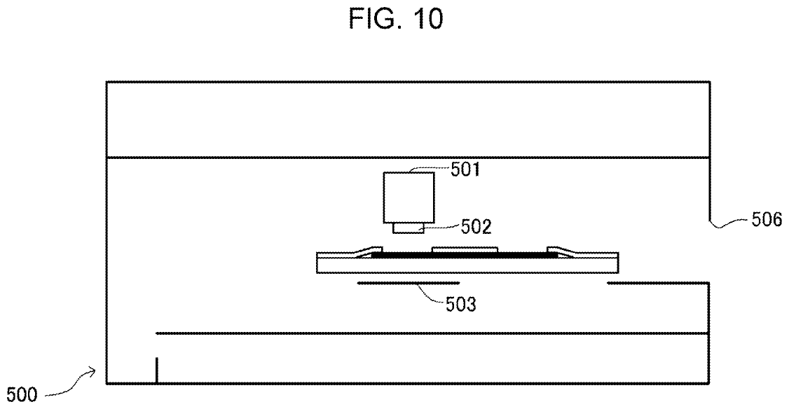

When the user inserts the infinite form tray as described above and instructs start of printing, the processor 10 controls the printing unit 50 to transport the infinite form tray pinching the print medium P and causes the printing unit 50 to discharge ink to the ink discharge positions when the two clearances 52b respectively pass vertically below the print head 502 as shown in FIGS. 10 and 11. In this case, the processor 10 corresponds to a control unit.

Subsequently, the processor 10 determines whether or not the printing of the print data is completed (step S135). Specifically, the processor 10 determines whether or not all the print data has been printed on the print medium. For example, after the first printing is completed in step S130, as shown in FIG. 8, only a part of the print data (“ABCDE”) is completed, so that it is determined that the printing of the print data is not completed in step S135 (step S135: N).

When it is determined that the printing of the print data is not completed in step S135, steps S105 to S135 are performed. When it is determined that the printing of the print data is completed in step S135, production of the printed matter is completed.

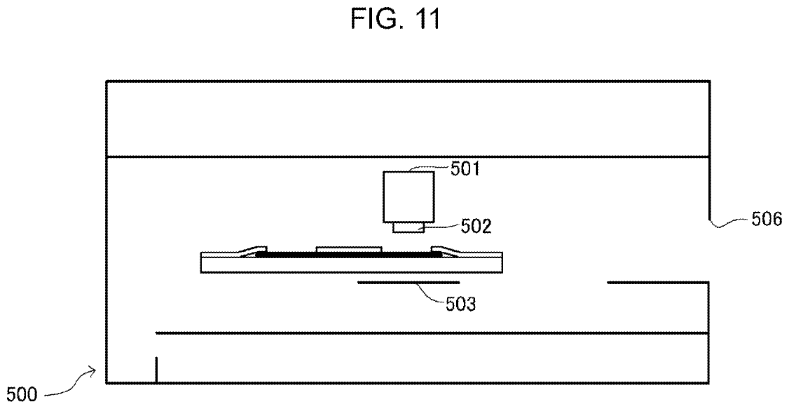

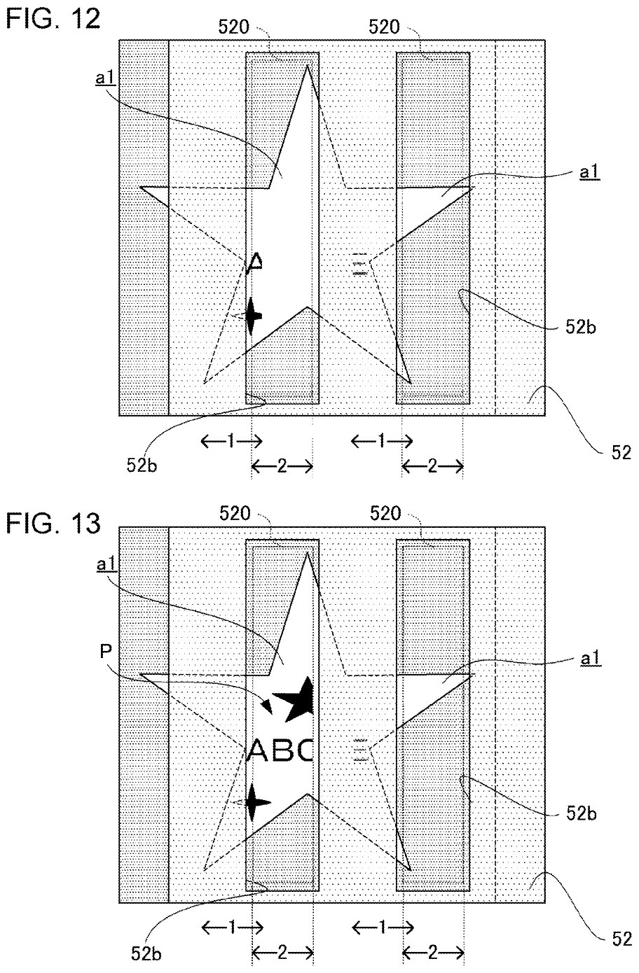

FIG. 12 shows a print medium set on the infinite form tray in a print medium set step (S105) for the second printing after the first printing shown in FIG. 8. In step S105, a position to which the cover 52 is shifted with respect to the base 51 may be guided by the scale mark of the base 51 as described above.

In the scan step (S110) for the second printing, an image as shown in FIG. 12 is generated as the scan data. In the scan data analysis step (S115) before the second printing, the processor 10 can recognize that the areas a1 (areas of the print medium exposed from the clearance of the cover) partially include pixels, where ink has been discharged, formed by the first printing. The processor 10 recognizes areas other than the pixels where ink has been discharged (printed areas) in the areas a1 that are areas of the print medium exposed from the clearance 52b as unprinted areas.

In an ink discharge position determination step (S125) for the second printing, the processor 10 determines pixels, which are located in the areas a1 and the print target areas 520 in a state where the cover 51 is shifted as shown in FIG. 12 and which are not located in printed areas, of the ink discharge pixels indicated by the print data, (pixels which are the ink discharge pixels indicated by the print data and which are located in the unprinted areas) as ink discharge positions in the second printing. When the user inserts the infinite form tray into the opening 506 in a second printing step (S130), a message may be outputted so that a side where the cover 52 protrudes from the base 51 is located on the front side of the housing 500. FIG. 13 shows a state in which the second printing is completed. After the second printing is completed, steps S105 to S125 for the third printing are performed.

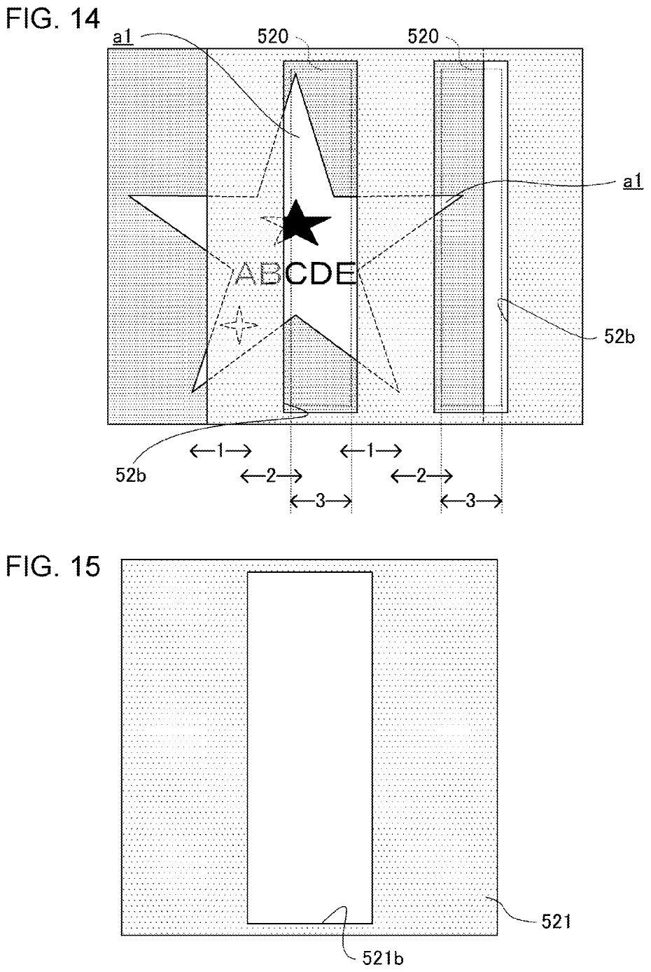

In the present embodiment, the printing of the print data is completed by three printings. FIG. 14 shows a state in which the third printing is completed. As shown in FIG. 14, in the third printing, printing is performed in a state in which the cover 52 is more shifted with respect to the base 51 than in the second printing. Of course, depending on the content of the print data and the shape of the cover 52, the printing of the print data may be completed by two printings or four or more printings. It is possible to produce a printed matter as shown in FIG. 14 by performing printing based on the print data on the infinite form print medium P through the steps as described above.

### 2. Second Embodiment

In the first embodiment, as the cover of the infinite form tray, the same cover is used by shifting the cover with respect to the same base. The cover need not be shifted with respect to the base. For this purpose, for example, when the printing of the print data is completed by two printings, a first base, a first cover where a clearance is provided, a second base, and a second cover where a clearance is provided in a position different from that of the first cover may be used. Further, for example, first time printing is performed by using the first base and the first cover where a clearance is provided and thereafter the first cover is replaced by the second cover and second time printing may be performed by using the first base and the second cover where a clearance is provided. That is, the second embodiment is different from the first embodiment in that a plurality of covers (the first cover and the second cover) whose clearance formation positions are different from each other are used. In the second embodiment, when the first base and the second base in an example of the former case are the same base, the example of the former case corresponds to an example of the latter case. Hereinafter, the example of the latter case will be described. That is, the base, the first cover, and the second cover are used. Further, a surface of the base (corresponding to the first base and the second base) of the second embodiment, which comes into contact with a print medium, has adhesiveness.

The printed matter production methods are common except for the content described with reference to FIG. 6 and step S105. In the second embodiment, the cover 52 shown in FIG. 4 (corresponding to the first cover) and a cover 521 shown in FIG. 15 (corresponding to the second cover) are used. The shape of outer circumference of the cover 52 and the shape of outer circumference of the cover 521 are a square (congruence) that is the same as the shape of the outer circumference of the top surface 51a of the base 51. The cover 521 is formed with a clearance 521b whose position is different from that of the clearance 52b of the cover 52.

Also in the second embodiment, the same print data (characters “ABCDE” and two star-shaped figures) as those in the first embodiment are printed on the same star-shaped print medium P as that in the first embodiment. In step S105 for the first printing of a production process of the second embodiment, the star-shaped print medium P is set on the top surface 51a of the base 51, and the cover 52 is set so as not to protrude from the top surface of the base 51 (see FIG. 5). Thereafter, when steps S110 to S130 are performed, as shown in FIG. 8, ink is discharged to ink discharge positions in an area which is the print target area 520 of the clearance 52b and which is the area a1.

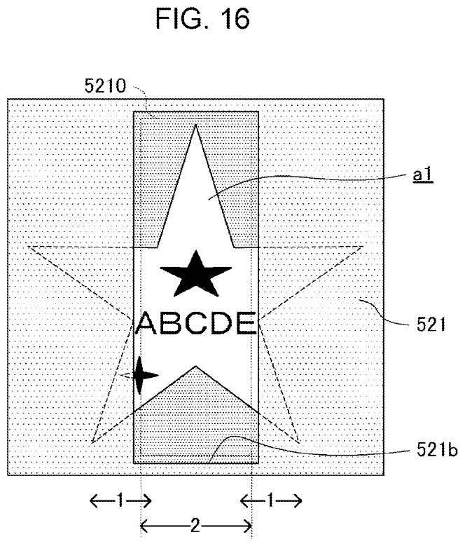

Subsequently, in step S105 of the second printing, a user does not peel off the print medium P set on the base 51, peels off the cover 52, and sets the cover 521 (see FIG. 15) instead of the cover 52 so that the cover 521 does not protrude from the top surface of the base 51. The cover 521 is set by the user so that the long side of the clearance 521b of the cover 521 is parallel to the long side of the clearance 52b of the cover 52 used for the first printing. In step S105, the processor 10 may guide a setting method (direction, position, and the like) of the cover to the user. Thereafter, when steps S110 to S130 are performed, as shown in FIG. 16, ink is discharged to pixels, which are located in a print target area 5210 of the clearance 521b and are located in the areas a1 and which are not located in printed areas, of the ink discharge pixels indicated by the print data (pixels which are the ink discharge pixels indicated by the print data and which are located in the unprinted area).

In the second embodiment, the cover 52 is set so as not to protrude from the base 51, so that even when there is no spatial margin around the infinite form tray in the transport path T3 of the infinite form tray, an insertion direction of the infinite form tray at the opening 506 is not limited. Therefore, the infinite form tray may be inserted into the opening 506 so that the long side of the clearance 52b of the cover 52 and the long side of the clearance 521b of the cover 521 are parallel to the main scanning direction, or the infinite form tray may be inserted into the opening 506 so that the long side of the clearance 52b and the long side of the clearance 521b are parallel to the sub-scanning direction.

In the second embodiment, the printing of the print data is completed by two printings. However, when all the print data has not been printed on the print medium by the two printings, one or more printings may be further performed. Specifically, after the second printing, the print medium is pinched by a third cover where a clearance is provided in a position different from those in both the first cover and the second cover, and the third printing may be performed on an unprinted area exposed from the clearance of the third cover. Further, when all the print data is printed on the print medium by N printings, printing may be performed by using one of N covers different from each other for each printing.

### 3. Other Embodiments

The embodiments described above are an example for exploiting the present disclosure, and other various embodiments can be employed. For example, the print system may be composed of one complex machine (having a printing function and a reading function), may be composed of a complex machine and a computer (for example, a PC, a tablet terminal, or the like), or may be composed of a scanner, a printer, and a computer, which are separated from each other. A guide for users and an operation such as enlargement/reduction rate change or position change of print data by a user may be performed on a UI (Uger Interface) unit included in the complex machine or may be performed on a UI unit of a PC or a tablet terminal coupled to a printer or a scanner.

A method other than the serial ink jet method may be employed for the printing unit. For example, a line ink jet method may be employed, or a transfer type or a sublimation type may be employed. The transport path of the infinite form tray pinching the print medium described in the above embodiments is an example, and the transport path is not limited to this. For example, the infinite form tray may be transported through a path indicated by T2 or T1 shown in FIG. 2. The infinite form tray may be transported by other various methods and transport paths according to the configuration of the printing unit. Further, printing may be performed by moving the printing unit with respect to a stationary infinite form tray.

The shapes of the base and the cover need not be a square. The shape of the outer circumference of the cover need not be the same as the shape of the outer circumference of the top surface of the base. The print medium may be pinched by the infinite form tray so as to partially protrude from the base. The shape of the clearance provided in the cover is not limited to the rectangle as described in the above embodiments. For example, the shape of the clearance may be a circular shape, an elliptical shape, a triangular shape, another polygonal shape, and the like. When the shapes of the base and the cover are congruent squares, even when the cover is rotated with respect to the base by a multiple of 90 degrees, it is possible to set the cover on the base so that the cover does not protrude from the outer circumference of the base.

In the first embodiment, the cover 52 is shifted in a direction toward the opening 506 in the sub-scanning direction. However, when there is a spatial margin where the cover does not interfere with another member in the transport path even if the cover is shifted in another direction, printing may be performed by shifting the cover in the main scanning direction or in a direction toward the rear side in the sub-scanning direction. When the shape of the print medium and the position of the print medium with respect to the base can be discriminated by other than visible light, the cover need not necessarily have transmissivity.

In the first embodiment and the second embodiment described above, in the scan step in step S110, the infinite form tray is mounted on the document table glass of the reading unit 60, and reading is performed by the image sensor of the reading unit 60. However, the reading may be performed in another way. For example, the processor 10 may recognize the shape of the print medium in a state of being pinched by the infinite form tray, an area exposed from the clearance of the cover, an unprinted area, and the like, which are included in an image captured by a digital camera handheld by the user. Alternatively, the processor 10 may recognize the shape of the print medium in a state of being pinched by the infinite form tray, an area exposed from the clearance of the cover, an unprinted area, and the like based on an image captured by a camera unit included in the carriage 501 of the printing unit 50 and the position of the carriage 501 in the main scanning direction when the image is captured. The camera unit includes a lens, an area image sensor, a light source, and the like and may be attached to the carriage 501 so that the print medium passing vertically below the print head 502 is contained in a visual field. The processor 10 alternatively performs movement of the carriage and transport of the infinite form tray and acquires an image captured by the camera unit at a predetermined timing. The processor 10 can recognize each area a1 to a4 and an unprinted area in the area a1 by analyzing the captured image. In these cases, the digital camera, the camera unit, and the processor 10 correspond to the discrimination unit.

The shape of the print medium, an area of the print medium that is exposed from the clearance of the cover, an unprinted area, and the like may be recognized based on an output signal of a PW (Paper Width) detection sensor mounted on the carriage 501 and a position in the main scanning direction of the carriage 501 when the signal is outputted. The PW detection sensor includes a light emitting element and a light receiving element and outputs a voltage signal according to the amount of light when the light receiving element receives light emitted from the light emitting element and reflected by the print medium. For example, reflection rates of the areas a1 to a4 shown in FIG. 5 are different from each other. The processor 10 can recognize each area a1 to a4 and an unprinted area in the area a1 by alternatively performing movement of the carriage and transport of the infinite form tray and acquiring the voltage signal of the PW detection sensor. In this case, the PW detection sensor and the processor 10 correspond to the discrimination unit.

After the first printing and before the second printing, at least either one of the print medium and the cover may be shifted with respect to the base so that a relative position between the print medium and the cover is changed. Regarding a setting method of the print medium (position and posture with respect to the base) and a setting method of the cover (position and posture with respect to the print medium set on the base) before the first printing, considering that a shift of the print medium is difficult to occur and the number of printing times is reduced to minimum, the print system may have a function to present preferable setting methods based on the scan data and the print data. Further, after the first printing and before the second printing, also regarding the setting method (a shifting method (a moving amount, a moving direction, a rotation angle, and the like)) of the print medium and the cover, a preferable setting method may be presented in the same way.

The first base and the second base may be the same or may be different. That is, there may be a first infinite form tray and a second infinite form tray. The first infinite form tray includes a first base and a first cover and the second infinite form tray includes a second base and a second cover. The formation position, the shape, and the like of the clearance of the first cover are different from those of the second cover. One side of the first base and one side of the first cover may be rotatably linked through a hinge, and one side of the second base and one side of the second cover may be rotatably linked through a hinge. The first printing may be performed while the first infinite form tray pinches the print medium, and the second printing may be performed while the second infinite form tray pinches the print medium that is removed from the first infinite form tray. When the first base and the second base are the same base, one side of the first cover may be rotatably linked to one side of the top surface of the base through a hinge and one side of the second cover may be rotatably linked to another side of the top surface of the base through a hinge. The cover and the base are not limited to being linked through a member such as a hinge, but the cover may be coupled to the base in an arbitrary way. Further, although the base has adhesiveness, the base need not have adhesiveness as long as the shift of the print medium can be suppressed.

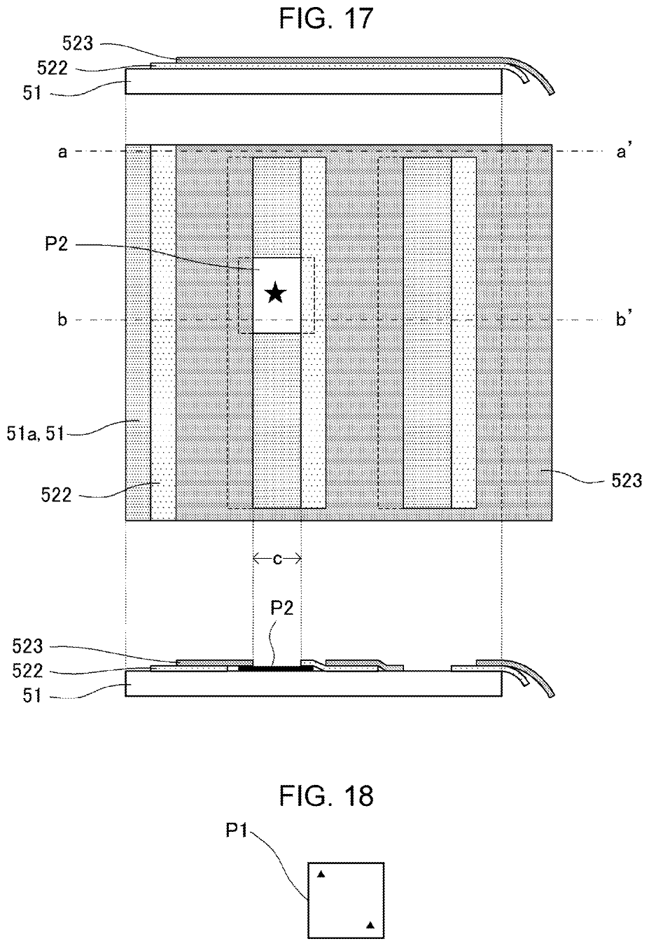

The print medium is pinched by two covers and the base, and printing may be performed on an area which is exposed from a clearance of one cover and which is also exposed from a clearance of the other cover. By using the two covers, the shape of the area from which the print medium is exposed can be various shapes according to an overlapping manner of the two covers. As a result, it is possible to perform printing on, for example, a print medium having a complicated shape and a print medium smaller than a clearance of a cover. FIG. 17 shows a situation in which a print medium P2 is pinched between the base and two covers 522 and 523 whose clearances have the same shape. In this example, the print medium P2 has a square shape, and the sides of the print medium P2 have the same length as that of the short side of the clearance of the cover 522 and 523. The print medium P2 is arranged on the top surface 51a of the base 51, and the cover 522 and the cover 523 are overlapped in this order. The long side of the clearance of the cover 522 and the long side of the clearance of the cover 523 are parallel to each other, and the cover 523 is shifted with respect to the cover 522 in a direction parallel to the short side of the clearance. The left end on a paper surface of the print medium P is pressed by the cover 523, and the right end of the print medium P is pressed by the cover 522. A range c of the print medium P2 is exposed from both the clearances of the covers 522 and 523. It is possible to perform printing on the range c exposed in a state where the print medium P2 is pressed by using the two covers in this way.

At least either one of the first printing and the second printing may be performed on an area of the print medium exposed from a clearance of an auxiliary cover in a state in which the print medium is pinched with the auxiliary cover where the clearance is formed. That is, printing may be performed on an area of the print medium exposed from a clearance newly formed by combining two covers, where a clearance is formed, in the first printing and the second printing (of course, the printing may be performed in the third or later printing).

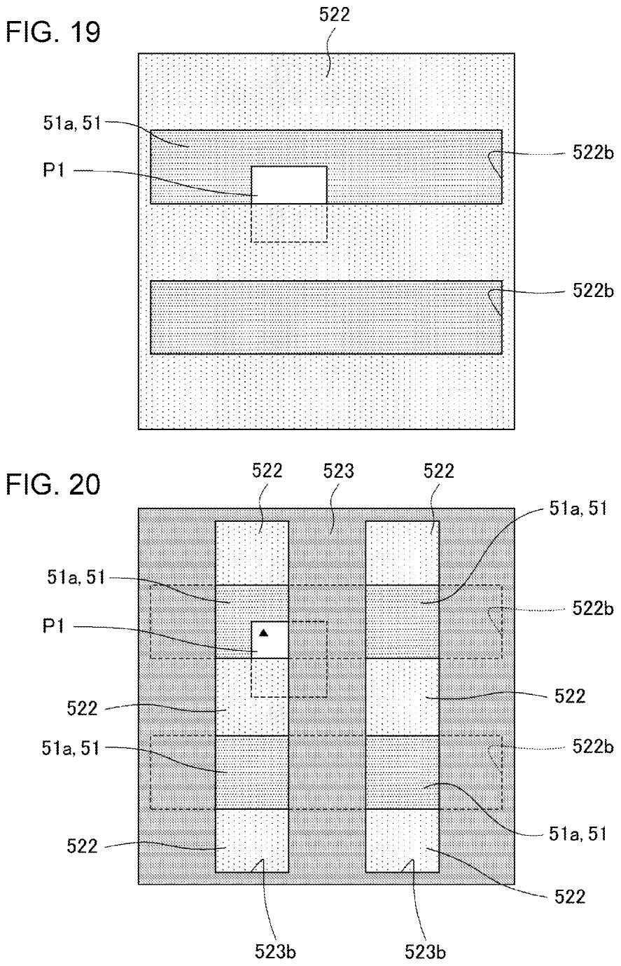

FIGS. 18 to 22 are diagrams showing a method of performing the first printing by using the two covers 522 and 523 and performing the second printing by shifting the two covers from the position of the first printing and using the two covers. FIG. 18 shows a printed matter desired to be produced in this example. In the printed matter, a marking is printed at each corner portion of a pair of opposing corners of a square print medium P1. To obtain such a printed matter, first, a user arranges the print medium P1 on the top surface 51a of the base 51 and arranges the cover 522 so that about one-half of the print medium P1 is exposed from a clearance 522b of the cover 522 as shown in FIG. 19. The length of a side of the print medium P1 is equal to or shorter than a short side of clearances 522b and 523b of the covers 522 and 523. The shapes and formation positions of the clearances of the cover 522 and the cover 523 are the same.

Subsequently, as shown in FIG. 20, the user arranges the cover 523 so as to overlap the cover 522 in a posture where the cover 523 is rotated by 90 degrees from the cover 522 and in a state where about one-half of the area of the print medium P that is exposed in the step shown in FIG. 19 is exposed. Therefore, when the covers 522 and 523 are overlapped as shown in FIG. 20, about a quarter of the entire print medium P1 is exposed. In this state, when steps S110 to S130 shown in FIG. 6 are performed, as a result, as shown in FIG. 20, a marking is printed at one corner portion of the printed matter shown in FIG. 18.

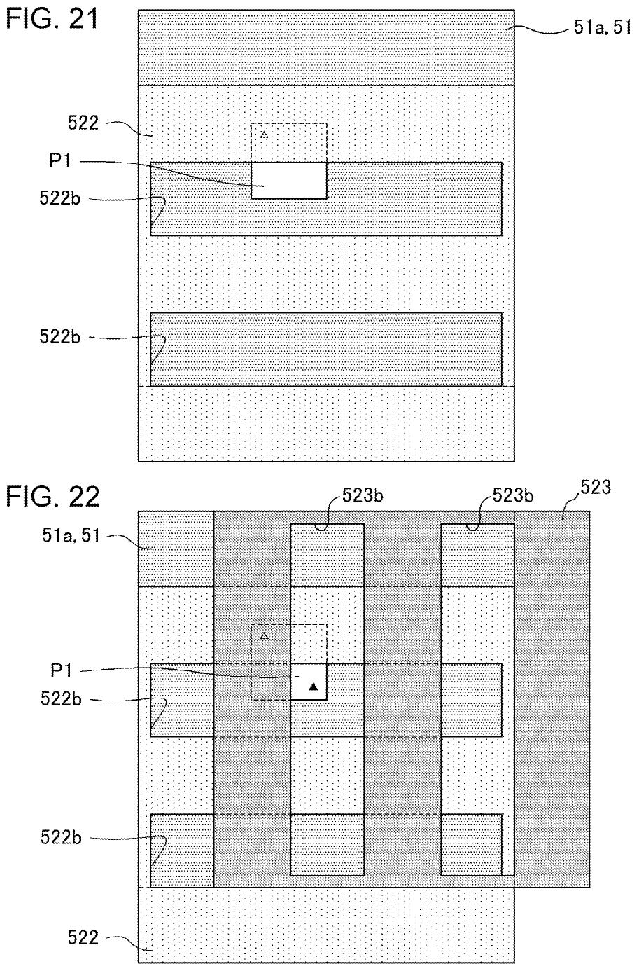

Subsequently, the user temporarily removes the cover 523. Then, as shown in FIG. 21, the user shifts the cover 522 in a direction parallel to the short side of the clearance 522b and exposes an area of the print medium P1 that is covered by the cover 522 during the first printing from the clearance 522b. Subsequently, as show in FIG. 22, the user arranges the cover 523, which is temporarily removed, so that an area of the print medium that is covered by the cover 523 during the first printing (see FIG. 20) is located in the clearance 523b of the cover 523 without changing the angle of the cover 523 with respect the print medium P1 from the angle during the first printing. By arranging as shown in FIG. 22, a corner portion located on a diagonal position of the corner portion of the print medium P1 exposed during the first printing is exposed (about a quarter of the entire area of the print medium P1 is exposed). In this state, when steps S110 to S130 shown in FIG. 6 are performed, as a result, as shown in FIG. 22, a marking is printed at the other corner portion of the printed matter shown in FIG. 18.

Further, the present disclosure can be applied as a program executed by a computer and a system (apparatus). The system, the program, and the method as described above may be realized as a single apparatus or may be realized by using components included in a plurality of apparatuses, and include various aspects. The system, the program, and the method can be appropriately changed such as a part is software and a part is hardware. Further, the disclosure is established also as a recording medium of a program that controls the system. Of course, the recording medium of the program may be a magnetic recording medium or a semiconductor memory. The same goes for any recording medium to be developed in the future.

What is claimed is:

1. A printed matter production method for producing a printed matter by using a base and a cover provided with a clearance, the printed matter production method comprising:
pinching a print medium between the base and the cover;
performing first printing on an area exposed from the clearance of the cover in the print medium;
after the first printing, shifting a relative position between the print medium and the cover and pinching again the print medium between the base and the cover; and
performing second printing on an unprinted area exposed from the clearance of the cover in the print medium that is pinched again.

2. A printed matter production method for producing a printed matter by using a first base, a first cover provided with a clearance, a second base, a second cover provided with a clearance in a position different from that of the first cover, the printed matter production method comprising:
pinching a print medium between the first base and the first cover;
performing first printing on an area exposed from the clearance of the first cover in the print medium;
after the first printing, pinching the print medium between the second base and the second cover; and
performing second printing on an unprinted area exposed from the clearance of the second cover in the print medium.

3. The printed matter production method according to claim 1, wherein
an exposed area is recognized by reading the print medium in a state of being pinched, and
printing is performed on the recognized area in the first printing.

4. The printed matter production method according to claim 3, wherein
an exposed unprinted area is recognized by reading the print medium in a state of being pinched, and
printing is performed on the recognized unprinted area in the second printing.

5. The printed matter production method according to claim 1, wherein
after the second printing, a relative position between the print medium and the cover is shifted, the print medium is pinched again, and third printing is performed on the unprinted area exposed from the cover.

6. The printed matter production method according to claim 2, wherein
after the second printing, the print medium is pinched by a third cover provided with a clearance in a position different from those in both the first cover and the second cover instead of the second cover, and third printing is performed on an unprinted area exposed from the clearance of the third cover.

7. The printed matter production method according to claim 1, wherein
a surface of the base, which comes into contact with the print medium, has adhesiveness.

8. The printed matter production method according to claim 2, wherein
surfaces of the first base and the second base, which come into contact with the print medium, have adhesiveness.

9. The printed matter production method according to claim 1, wherein
at least either one of the first printing and the second printing is performed on an area of the print medium exposed from a clearance of an auxiliary cover in a state in which the print medium is pinched with the auxiliary cover where a clearance is formed.

10. The printed matter production method according to claim 2, wherein
the first base and the second base are the same base.

11. A printing system that performs printing on a print medium pinched by a base and a cover provided with a clearance, the printing system comprising:
a printing unit;
a discrimination unit that discriminates an area of the print medium exposed from the clearance of the cover; and
a control unit that causes the printing unit to perform first printing on the area based on a discrimination result, wherein
after the first printing, the discrimination unit discriminates an unprinted area of the print medium exposed from the clearance of the cover, and
the control unit causes the printing unit to perform second printing on the unprinted area based on a discrimination result.
